(19) United States
(12) Patent Application Publication
(10) Pub. No.: US 2008/0183972 A1
(43) Pub. Date: Jul. 31, 2008

(54) Snoop Filtering Using a Snoop Request Cache

(76) Inventor: James Norris Dieffenderfer, Apex, NC (US)

Correspondence Address: QUALCOMM INCORPORATED, 5775 MOREHOUSE DR., SAN DIEGO, CA, 92121, US

(21) Appl. No.: 11/627,705

(22) Filed: Jan. 26, 2007

(51) Int. Cl. G06F 12/08

(52) U.S. Cl. 711/146; 711/E12.033

(57) ABSTRACT

A snoop request cache maintains records of previously issued snoop requests. Upon writing shared data, a snooping entity performs a lookup in the cache. If the lookup hits (and, in some embodiments, includes an identification of a target processor) the snooping entity suppresses the snoop request. If the lookup misses (or hits but the hitting entry lacks an identification of the target processor) the snooping entity allocates an entry in the cache (or sets an identification of the target processor) and directs a snoop request such to the target processor, to change the state of a corresponding line in the processor's L1 cache. When the processor reads shared data, it performs a snoop cache request lookup, and invalidates a hitting entry in the event of a hit (or clears it processor identification from the hitting entry), so that other snooping entities will not suppress snoop requests to it.

### BACKGROUND

The present invention relates in general to cache coherency in multi-processor computing systems, and in particular to a snoop request cache to filter snoop requests.

Many modern software programs are written as if the computer executing them had a very large (ideally, unlimited) amount of fast memory. Most modern processors simulate that ideal condition by employing a hierarchy of memory types, each having different speed and cost characteristics. The memory types in the hierarchy vary from very fast and very expensive at the top, to progressively slower but more economical storage types in lower levels. Due to the spatial and temporal locality characteristics of most programs, the instructions and data executing at any given time, and those in the address space near them, are statistically likely to be needed in the very near future, and may be advantageously retained in the upper, high-speed hierarchical layers, where they are readily available.

A representative memory hierarchy may comprise an array of very fast General Purpose Registers (GPRs) in the processor core at the top level. Processor registers may be backed by one or more cache memories, known in the art as Level-1 or L1 caches. L1 caches may be formed as memory arrays on the same integrated circuit as the processor core, allowing for very fast access, but limiting the L1 cache's size. Depending on the implementation, a processor may include one or more on- or off-chip Level-2 or L2 caches. L2 caches are often implemented in SRAM for fast access times, and to avoid the performance-degrading refresh requirements of DRAM. Because there are fewer restraints on L2 cache size, L2 caches may be several times the size of L1 caches, and in multi-processor systems, one L2 cache may underlie two or more L1 caches. High performance computing processors may have additional levels of cache (e.g., L3). Below all the caches is main memory, usually implemented in DRAM or SDRAM for maximum density and hence lowest cost per bit.

The cache memories in a memory hierarchy improve performance by providing very fast access to small amounts of data, and by reducing the data transfer bandwidth between one or more processors and main memory. The caches contain copies of data stored in main memory, and changes to cached data must be reflected in main memory. In general, two approaches have developed in the art for propagating cache writes to main memory: write-through and copy-back. In a write-through cache, when a processor writes modified data to its L1 cache, it additionally (and immediately) writes the modified data to lower-level cache and/or main memory. Under a copy-back scheme, a processor may write modified data to an L1 cache, and defer updating the change to lower-level memory until a later time. For example, the write may be deferred until the cache entry is replaced in processing a cache miss, a cache coherency protocol requests it, or under software control.

In addition to assuming large amounts of fast memory, modern software programs execute in a conceptually contiguous and largely exclusive virtual address space. That is, each program assumes it has exclusive use of all memory resources, with specific exceptions for expressly shared memory space. Modern processors, together with sophisticated operating system software, simulate this condition by mapping virtual addresses (those used by programs) to physical addresses (which address actual hardware, e.g., caches and main memory). The mapping and translation of virtual to physical addresses is known as memory management. Memory management allocates resources to processors and programs, defines cache management policies, enforces security, provides data protection, enhances reliability, and provides other functionality by assigning attributes to segments of main memory called pages. Many different attributes may be defined and assigned on a per-page basis, such as supervisor/user, read-write/read-only, exclusive/shared, instruction/data, cache write-through/copy-back, and many others. Upon translating virtual addresses to physical addresses, data take on the attributes defined for the physical page.

One approach to managing multi-processor systems is to allocate a separate “thread” of program execution, or task, to each processor. In this case, each thread is allocated exclusive memory, which it may read and write without concern for the state of memory allocated to any other thread. However, related threads often share some data, and accordingly are each allocated one or more common pages having a shared attribute. Updates to shared memory must be visible to all of the processors sharing it, raising a cache coherency issue. Accordingly, shared data may also have the attribute that it must “write-through” an L1 cache to an L2 cache (if the L2 cache backs the L1 cache of all processors sharing the page) or to main memory. Additionally, to alert other processors that the shared data has changed (and hence their own L1-cached copy, if any, is no longer valid), the writing processor issues a request to all sharing processors to invalidate the corresponding line in their L1 cache. Inter-processor cache coherency operations are referred to herein generally as snoop requests, and the request to invalidate an L1 cache line is referred to herein as a snoop kill request or simply snoop kill. Snoop kill requests arise, of course, in scenarios other than the one described above.

Upon receiving a snoop kill request, a processor must invalidate the corresponding line in its L1 cache. A subsequent attempt to read the data will miss in the L1 cache, forcing the processor to read the updated version from a shared L2 cache or main memory. Processing the snoop kill, however, incurs a performance penalty as it consumes processing cycles that would otherwise be used to service loads and stores at the receiving processor. In addition, the snoop kill may require a load/store pipeline to reach a state where data hazards that are complicated by the snoop are known to have been resolved, stalling the pipeline and further degrading performance.

Various techniques are known in the art to reduce the number of processor stall cycles incurred by a processor being snooped. In one such technique, a duplicate copy of the L1 tag array is maintained for snoop accesses. When a snoop kill is received, a lookup is performed in the duplicate tag array. If this lookup misses, there is no need to invalidate the corresponding entry in the L1 cache, and the penalty associated with processing the snoop kill is avoided. However, this solution incurs a large penalty in silicon area, as the entire tag for each L1 cache must be duplicated, increasing the minimum die size and also power consumption. Additionally, a processor must update two copies of the tag every time the L1 cache is updated.

Another known technique to reduce the number of snoop kill requests that a processor must handle is to form “snooper groups” of processors that may potentially share memory. Upon updating an L1 cache with shared data (with write-through to a lower level memory), a processor sends a snoop kill request only to the other processors within its snooper group. Software may define and maintain snooper groups, e.g., at a page level or globally. While this technique reduces the global number of snoop kill requests in a system, it still requires that each processor within each snooper group process a snoop kill request for every write of shared data by any other processor in the group.

Yet another known technique to reduce the number of snoop kill requests is store gathering. Rather then immediately executing each store instruction by writing small amounts of data to the L1 cache, a processor may include a gather buffer or register bank to collect store data. When a cache line, half-line, or other convenient quantity of data is gathered, or when a store occurs to a different cache line or half-line than the one being gathered, the gathered store data is written to the L1 cache all at once. This reduces the number of write operations to the L1 cache, and consequently the number of snoop kill requests that must be sent to another processor. This technique requires additional on-chip storage for the gather buffer or gather buffers, and may not work well when store operations are not localized to the extent covered by the gather buffers.

Still another known technique is to filter snoop kill requests at the L2 cache by making the L2 cache fully inclusive of the L1 cache. In this case, a processor writing shared data performs a lookup in the other processor's L2 cache before snooping the other processor. If the L2 lookup misses, there is no need to snoop the other processor's L1 cache, and the other processor does not incur the performance degradation of processing a snoop kill request. This technique reduces the total effective cache size by consuming L2 cache memory to duplicate one or more L1 caches. Additionally, this technique is ineffective if two or more processors backed by the same L2 cache share data, and hence must snoop each other.

### SUMMARY

According to one or more embodiments described and claimed herein, one or more snoop request caches maintain records of snoop requests. Upon writing data having a shared attribute, a processor performs a lookup in a snoop request cache. If the lookup misses, the processor allocates an entry in the snoop request cache and directs a snoop request (such as a snoop kill) to one or more processors. If the snoop request cache lookup hits, the processor suppresses the snoop request. When a processor reads shared data, it also performs a snoop cache request lookup, and invalidates a hitting entry in the event of a hit.

One embodiment relates to a method of issuing a data cache snoop request to a target processor having a data cache, by a snooping entity. A snoop request cache lookup is performed in response to a data store operation, and the data cache snoop request is suppressed in response to a hit.

Another embodiment relates to a computing system. The system includes memory and a first processor having a data cache. The system also includes a snooping entity operative to direct a data cache snoop request to the first processor upon writing to memory data having a predetermined attribute. The system further includes at least one snoop request cache comprising at least one entry, each valid entry indicative of a prior data cache snoop request. The snooping entity is further operative to perform a snoop request cache lookup prior to directing a data cache snoop request to the first processor, and to suppress the data cache snoop request in response to a hit.

### BRIEF DESCRIPTION OF THE DRAWINGS

FIG. 1 is a functional block diagram of a shared snoop request cache in a multi-processor computing system.

FIG. 2 is a functional block diagram of multiple dedicated snoop request caches per processor in a multi-processor computing system.

FIG. 3 is a functional block diagram of a multi-processor computing system including a non-processor snooping entity.

FIG. 4 is a functional block diagram of a single snoop request cache associated with each processor in a multi-processor computing system.

FIG. 5 is a flow diagram of a method of a method of issuing a snoop request.

### DETAILED DESCRIPTION

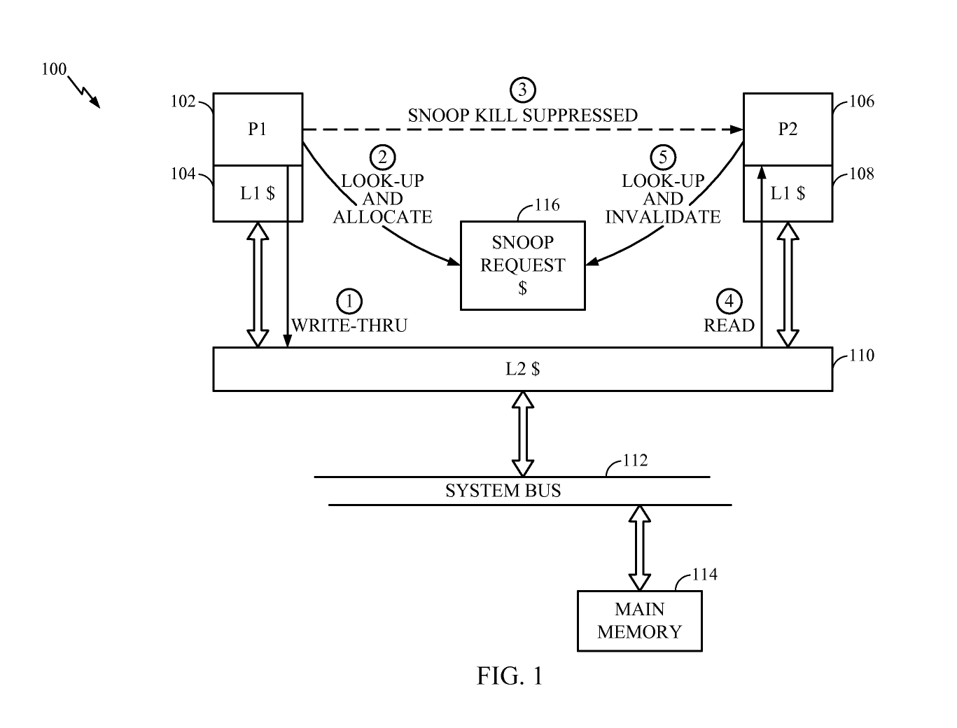

FIG. 1 depicts a multi-processor computing system, indicated generally by the numeral 100. The computer 100 includes a first processor 102 (denoted P1) and its associated L1 cache 104. The computer 100 additionally includes a second processor 106 (denoted P2) and its associated L1 cache 108. Both L1 caches are backed by a shared L2 cache 110, which transfers data across a system bus 112 to and from main memory 114. The processors 102, 106 may include dedicated instruction caches (not shown), or may cache both data and instructions in the L1 and L2 caches. Whether the caches 104, 108, 110 are dedicated data caches or unified instruction/data caches has no impact on the embodiments describe herein, which operate with respect to cached data. As used herein, a “data cache” operation, such as a data cache snoop request, refers equally to an operation directed to a dedicated data cache and one directed to data stored in a unified cache.

Software programs executing on processors P1 and P2 are largely independent, and their virtual addresses are mapped to respective exclusive pages of physical memory. However, the programs do share some data, and at least some addresses are mapped to a shared memory page. To ensure that each processor's L1 cache 104, 108 contains the latest shared data, the shared page has the additional attribute of L1 write-through. Accordingly, any time P1 or P2 update a shared memory address, the L2 cache 110, as well as the processor's L1 cache 104, 108, is updated. Additionally, the updating processor 102, 106 sends a snoop kill request to the other processor 102, 106, to invalidate a possible corresponding line in the other processor's L1 cache 104, 108. This incurs performance degradation at the receiving processor 102, 106, as explained above.

A snoop request cache 116 caches previous snoop kill requests, and may obviate superfluous snoop kills, improving overall performance. FIG. 1 diagrammatically depicts this process. At step 1, processor P1 writes data to a memory location having a shared attribute. As used herein, the term “granule” refers to the smallest cacheable quantum of data in the computer system 100. In most cases, a granule is the smallest L1 cache line size (some L2 caches have segmented lines, and can store more than one granule per line). Cache coherency is maintained on a granule basis. The shared attribute (or alternatively, a separate write-through attribute) of the memory page containing the granule forces P1 to write its data to the L2 cache 110, as well as its own L1 cache 104.

At step 2, the processor P1 performs a lookup in the snoop request cache 116. If the snoop request cache 116 lookup misses, the processor P1 allocates an entry in the snoop request cache 116 for the granule associated with P1's store data, and sends a snoop kill request to processor P2 to invalidate any corresponding line (or granule) in P2's L1 cache 108 (step 3). If the processor P2 subsequently reads the granule, it will miss in its L1 cache 108, forcing an L2 cache 110 access, and the latest version of the data will be returned to P2.

If processor P1 subsequently updates the same granule of shared data, it will again perform a write-through to the L2 cache 110 (step 1). P1 will additionally perform a snoop request cache 116 lookup (step 2). This time, the snoop request cache 116 lookup will hit. In response, the processor P1 suppresses the snoop kill request to the processor P2 (step 3 is not executed). The presence of an entry in the snoop request cache 116, corresponding to the granule to which it is writing, assures processor P1 that a previous snoop kill request already invalidated the corresponding line in P2's L1 cache 108, and any read of the granule by P2 will be forced to access the L2 cache 110. Thus, the snoop kill request is not necessary for cache coherency, and may be safely suppressed.

However, the processor P2 may read data from the same granule in the L2 cache 110—and change its corresponding L1 cache line state to valid—after the processor P1 allocates an entry in the snoop request cache 116. In this case, the processor P1 should not suppress a snoop kill request to the processor P2 if P1 writes a new value to the granule, since that would leave different values in processor P2's L1 cache and the L2 cache. To “enable” snoop kills issued by the processor P1 to reach the processor P2 (i.e., not be suppressed), upon reading the granule at step 4, the processor P2 performs a lookup on the granule in the snoop request cache 116, at step 5. If this lookup hits, the processor P2 invalidates the hitting snoop request cache entry. When the processor P1 subsequently writes to the granule, it will issue a new snoop kill request to the processor P2 (by missing in the snoop request cache 116). In this manner, the two L1 caches 104, 108 maintain coherency for processor P1 writes and processor P2 reads, with the processor P1 issuing the minimum number of snoop kill requests required to do so.

On the other hand, if the processor P2 writes the shared granule, it too must do a write-through to the L2 cache 110. In performing a snoop request cache 116 lookup, however, it may hit an entry that was allocated when processor P1 previously wrote the granule. In this case, suppressing a snoop kill request to the processor P1 would leave a stale value in P1's L1 cache 104, resulting in non-coherent L1 caches 104, 108. Accordingly, in one embodiment, upon allocating a snoop request cache 116 entry, the processor 102, 106 performing the write-through to the L2 cache 110 includes an identifier in the entry. Upon subsequent writes, the processor 102, 106 should only suppress a snoop kill request if a hitting entry in the snoop request cache 116 includes that processor's identifier. Similarly, when performing a snoop request cache 116 lookup upon reading the granule, a processor 102, 106 must only invalidate a hitting entry if it includes a different processor's identifier. In one embodiment, each cache 116 entry includes an identification flag for each processor in the system that may share data, and processors inspect, and set or clear the identification flags as required upon a cache hit.

The snoop request cache 116 may assume any cache organization or degree of association known in the art. The snoop request cache 116 may also adopt any cache element replacement strategy known in the art. The snoop request cache 116 offers performance benefits if a processor 102, 106 writing shared data hits in the snoop request cache 116 and suppresses snoop kill requests to one or more other processors 102, 106. However, if a valid snoop request cache 116 element is replaced due to the number of valid entries exceeding available cache 116 space, no erroneous operation or cache non-coherency results—at worst, a subsequent snoop kill request may be issued to a processor 102, 106 for which the corresponding L1 cache line is already invalid.

In one or more embodiments, tags to the snoop request cache 116 entries are formed from the most significant bits of the granule address and a valid bit, similar to the tags in the L1 caches 104, 108. In one embodiment, the “line,” or data stored in a snoop request cache 116 entry is simply a unique identifier of the processor 102, 106 that allocated the entry (that is, the processor 102, 106 issuing a snoop kill request), which may for example comprise an identification flag for each processor in the system 100 that may share data. In another embodiment, the source processor identifier may itself be incorporated into the tag, so a processor 102, 106 will only hit against its own entries in a cache lookup pursuant to a store of shared data. In this case, the snoop request cache 116 is simply a Content Addressable Memory (CAM) structure indicating a hit or miss, without a corresponding RAM element storing data. Note that when performing the snoop request cache 116 lookup pursuant to a load of shared data, the other processors' identifiers must be used.

In another embodiment, the source processor identifier may be omitted, and an identifier of each target processor—that is, each processor 102, 106 to whom a snoop kill request has been sent—is stored in each snoop request cache 116 entry. The identification may comprise an identification flag for each processor in the system 100 that may share data. In this embodiment, upon writing to a shared data granule, a processor 102, 106 hitting in the snoop request cache 116 inspects the identification flags, and suppresses a snoop kill request to each processor whose identification flag is set. The processor 102, 106 sends a snoop kill request to each other processor whose identification flag is clear in the hitting entry, and then sets the target processors' flag(s). Upon reading a shared data granule, a processor 102, 106 hitting in the snoop request cache 116 clears its own identification flag in lieu of invalidating the entire entry—clearing the way for snoop kill requests to be directed to it, but still blocked from being sent to other processors whose corresponding cache line remains invalid.

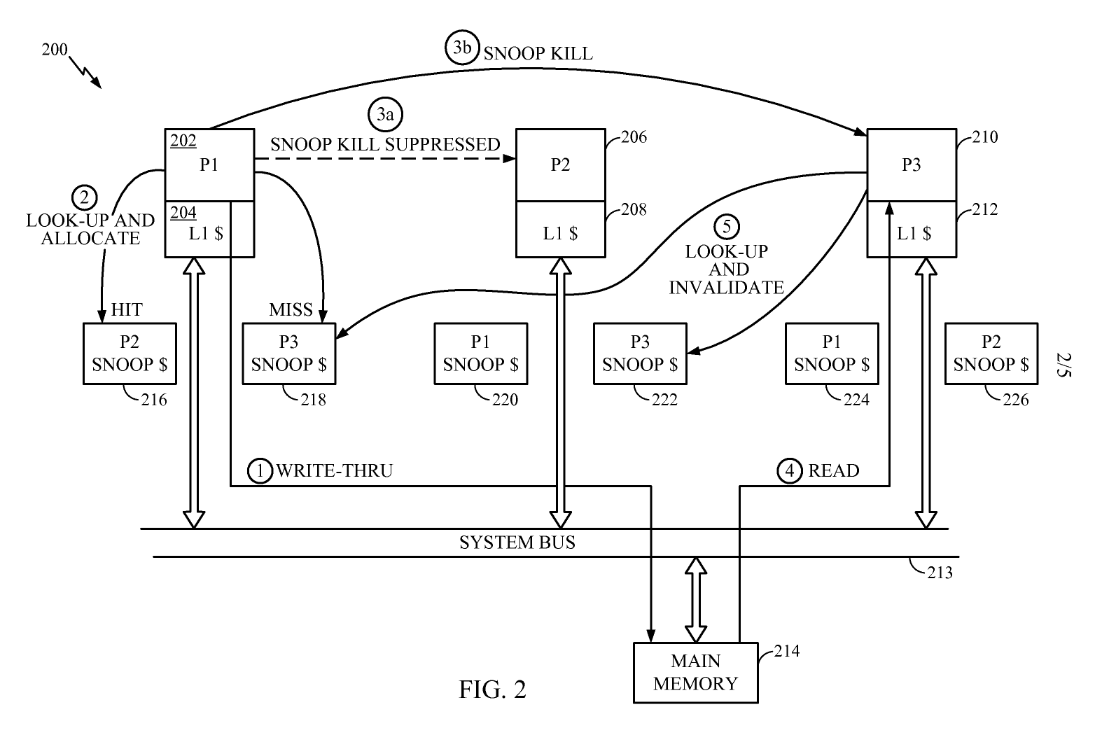

Another embodiment is described with reference to FIG. 2, depicting a computer system 200 including a processor P1 202 having an L1 cache 204, a processor P2 206 having an L1 cache 208, and a processor P3 210 having an L1 cache 212. Each L1 cache 204, 208, 212 connects across the system bus 213 to main memory 214. Note that, as evident in FIG. 2, no embodiment herein requires or depends on the presence or absence of an L2 cache or any other aspect of the memory hierarchy. Associated with each processor 202, 206, 210 is a snoop request cache 216, 218, 220, 222, 224, 226 dedicated to each other processor 202, 206, 210 (having a data cache) in the system 200 that can access shared data. For example, associated with processor P1 is a snoop request cache 216 dedicated to processor P2 and a snoop request cache 218 dedicated to processor P3. Similarly, associated the processor P2 are snoop request caches 220, 222 dedicated to processors P1 and P3, respectively. Finally, snoop request caches 224, 226, respectively dedicated to processors P1 and P2, are associated with processor P3. In one embodiment, the snoop request caches 216, 218, 220, 222, 224, 226 are CAM structures only, and do not include data lines.

The operation of the snoop request caches is depicted diagrammatically with a representative series of steps in FIG. 2. At step 1, the processor P1 writes to a shared data granule. Data attributes force a write-through of P1's L1 cache 204 to memory 214. The processor P1 performs a lookup in both snoop request caches associated with it—that is, both the snoop request cache 216 dedicated to processor P2, and the snoop request cache 218 dedicated to processor P3, at step 2. In this example, the P2 snoop request cache 216 hits, indicating that P1 previously sent a snoop kill request to P2 whose snoop request cache entry has not been invalidated or over-written by a new allocation. This means the corresponding line in P2's L2 cache 208 was (and remains) invalidated, and the processor P1 suppresses a snoop kill request to processor P2, as indicated by a dashed line at step 3a.

In this example, the lookup of the snoop request cache 218 associated with P1 and dedicated to P3 misses. In response, the processor P1 allocates an entry for the granule in the P3 snoop request cache 218, and issues a snoop kill request to the processor P3, at step 3b. This snoop kill invalidates the corresponding line in P3's L1 cache, and forces P3 to go to main memory on its next read from the granule, to retrieve the latest data (as updated by P1's write).

Subsequently, as indicated at step 4, the processor P3 reads from the data granule. The read misses in its own L1 cache 212 (as that line has been invalidated by P1's snoop kill), and retrieves the granule from main memory 214. At step 5, the processor P3 performs a lookup in all snoop request caches dedicated to it—that is, in both P1's snoop request cache 218 dedicated to P3, and P2's snoop request cache 222, which is also dedicated to P3. If either (or both) cache 218, 222 hits, the processor P3 invalidates the hitting entry, to prevent the corresponding processor P1 or P2 from suppressing snoop kill requests to P3 if either processor P1 or P2 writes a new value to the shared data granule.

Generalizing from this specific example, in an embodiment such as that depicted in FIG. 2—where associated with each processor is a separate snoop request cache dedicated to each other processor sharing data—a processor writing to a shared data granule performs a lookup in each snoop request cache associated with writing processor. For each one that misses, the processor allocates an entry in the snoop request cache and sends a snoop kill request to the processor to which the missing snoop request cache is dedicated. The processor suppresses snoop kill requests to any processor whose dedicated cache hits. Upon reading a shared data granule, a processor performs a lookup in all snoop request caches dedicated to it (and associated with other processors), and invalidates any hitting entries. In this manner, the L1 caches 204, 208, 212 maintain coherency for data having a shared attribute.

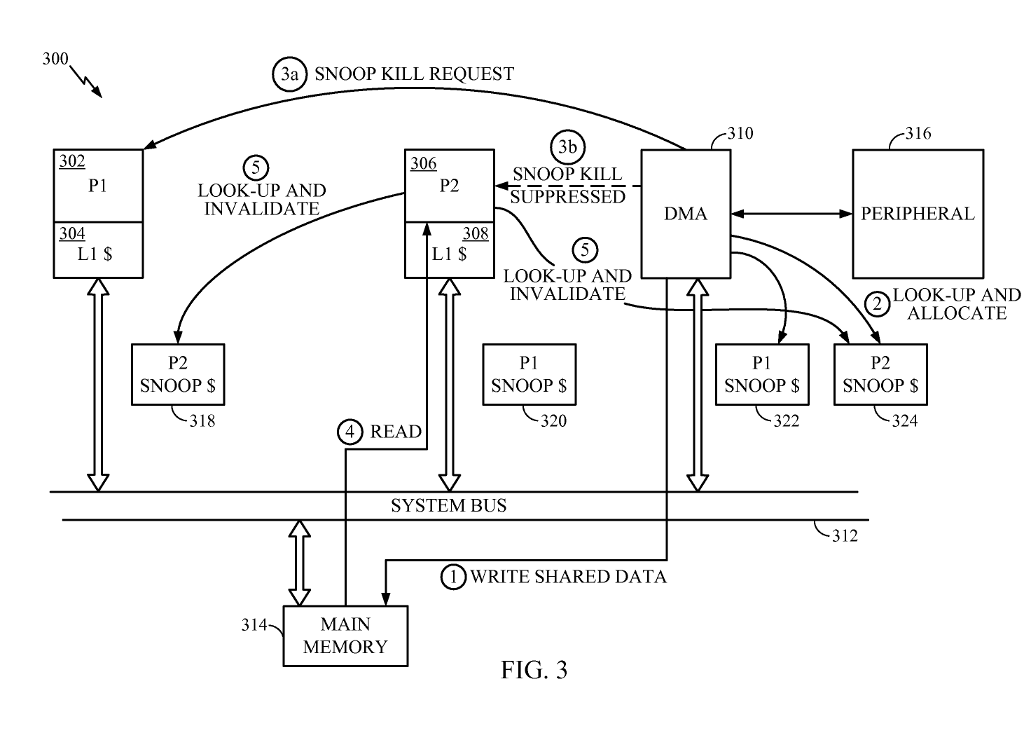

While embodiments of the present invention are described herein with respect to processors, each having an L1 cache, other circuits or logical/functional entities within the computer system 10 may participate in the cache coherency protocol. FIG. 3 depicts an embodiment similar to that of FIG. 2, with a non-processor snooping entity participating in the cache coherency protocol. The system 300 includes a processor P1 302 having an L1 cache 304, and a processor P2 306 having an L1 cache 308.

The system additionally includes a Direct Memory Access (DMA) controller 310. As well known in the art, a DMA controller 310 is a circuit operative to move blocks of data from a source (memory or a peripheral) to a destination (memory or a peripheral) autonomously of a processor. In the system 300, the processors 302, 306, and DMA controller 310 access main memory 314 via the system bus 312. In addition, the DMA controller 310 may read and write data directly from a data port on a peripheral 316. If the DMA controller 310 is programmed by a processor to write to shared memory, it must participate in the cache coherency protocol to ensure coherency of the L1 data caches 304, 308.

Since the DMA controller 310 participates in the cache coherency protocol, it is a snooping entity. As used herein, the term “snooping entity” refers to any system entity that may issue snoop requests pursuant to a cache coherency protocol. In particular, a processor having a data cache is one type of snooping entity, but the term “snooping entity” encompasses system entities other than processors having data caches. Non-limiting examples of snooping entities other than the processors 302, 306 and DMA controller 310 include a math or graphics co-processor, a compression/decompression engine such as an MPEG encoder/decoder, or any other system bus master capable of accessing shared data in memory 314.

Associated with each snooping entity 302, 306, 310 is a snoop request cache dedicated to each processor (having a data cache) with which the snooping entity may share data. In particular, a snoop request cache 318 is associated with processor P1 and dedicated to processor P2. Similarly, a snoop request cache 320 is associated with processor P2 and dedicated to processor P1. Associated with the DMA controller 310 are two snoop request caches: a snoop request cache 322 dedicated to processor P1 and a snoop request cache 324 dedicated to processor P2.

The cache coherency process is depicted diagrammatically in FIG. 3. The DMA controller 310 writes to a shared data granule in main memory 314 (step 1). Since either or both processors P1 and P2 may contain the data granule in their L1 cache 304, 308, the DMA controller 310 would conventionally send a snoop kill request to each processor P1, P2. First, however, the DMA controller 310 performs a lookup in both of its associated snoop request caches (step 2)—that is, the cache 322 dedicated to processor P1 and the cache 324 dedicated to processor P2. In this example, the lookup in the cache 322 dedicated to processor P1 misses, and the lookup in the cache 324 dedicated to processor P2 hits. In response to the miss, the DMA controller 310 sends a snoop kill request to the processor P1 (step 3a) and allocates an entry for the data granule in the snoop request cache 322 dedicated to processor P1. In response to the hit, the DMA controller 310 suppresses a snoop kill request that would otherwise have been sent to the processor P2 (step 3b).

Subsequently, the processor P2 reads from the shared data granule in memory 314 (step 4). To enable snoop kill requests directed to itself from all snooping entities, the processor P2 performs a look up in each cache 318, 324 associated with another snooping entity and dedicated to the processor P2 (i.e., itself). In particular, the processor P2 performs a cache lookup in the snoop request cache 318 associated with processor P1 and dedicated to processor P2, and invalidates any hitting entry in the event of a cache hit. Similarly, the processor P2 performs a cache lookup in the snoop request cache 324 associated with the DMA controller 310 and dedicated to processor P2, and invalidates any hitting entry in the event of a cache hit. In this embodiment, the snoop request caches 318, 320, 322, 324 are pure CAM structures, and do not require processor identification flags in the cache entries.

Note that no snooping entity 302, 306, 310 has associated with it any snoop request cache dedicated to the DMA controller 310. Since the DMA controller 310 does not have a data cache, there is no need for another snooping entity to direct a snoop kill request to the DMA controller 310 to invalidate a cache line. In addition, note that, while the DMA controller 310 participates in the cache coherency protocol by issuing snoop kill requests upon writing shared data to memory 314, upon reading from a shared data granule, the DMA controller 310 does not perform any snoop request cache lookup for the purpose of invalidating a hitting entry. Again, this is due to the DMA controller 310 lacking any cache for which it must enable another snooping entity to invalidate a cache line, upon writing to shared data.

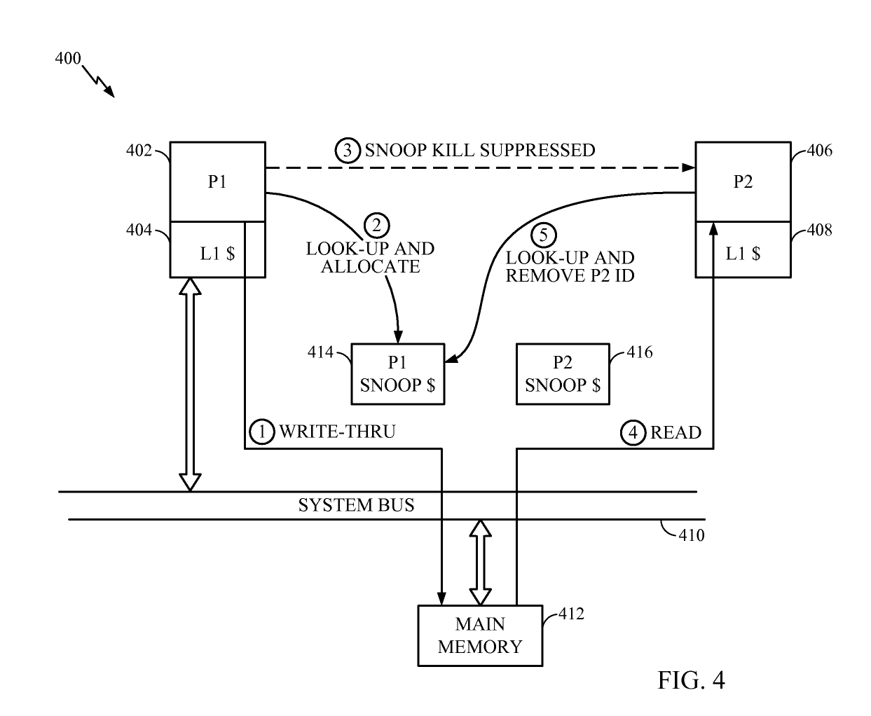

Yet another embodiment is described with reference to FIG. 4, depicting a computer system 400 including two processors: P1 402 having L1 cache 404 and P2 406 having L1 cache 408. The processors P1 and P2 connect across a system bus 410 to main memory 412. A single snoop request cache 414 is associated with processor P1, and a separate snoop request cache 416 is associated with processor P2. Each entry in each snoop request cache 414, 416 includes a flag or field identifying a different processor to which the associated processor may direct a snoop request. For example, entries in the snoop request cache 414 include identification flags for processor P2, as well as any other processors (not shown) in the system 400 with which P1 may share data.

Operation of this embodiment is depicted diagrammatically in FIG. 4. Upon writing to a data granule having a shared attribute, the processor P1 misses in its L1 cache 404, and writes-through to main memory 412 (step 1). The processor P1 performs a cache lookup in the snoop request cache 414 associated with it (step 2). In response to a hit, the processor P1 inspects the processor identification flags in the hitting entry. The processor P1 suppresses sending a snoop request to any processor with which it shares data and whose identification flag in the hitting entry is set (e.g., P2, as depicted by the dashed line at step 3). If a processor identification flag is clear and the processor P1 shares the data granule with the indicated processor, the processor P1 sends a snoop request to that processor, and sets the target processor's identification flag in the hitting snoop request cache 414 entry. If the snoop request cache 414 lookup misses, the processor P1 allocates an entry, and sets the identification flag for each processor to which it sends a snoop kill request.

When any other processor performs a load from a shared data granule, misses in its L1 cache, and retrieves the data from main memory, it performs cache lookups in the snoop request caches 414, 416 associated with each processor with which it shares the data granule. For example, processor P2 reads from memory data from a granule it shares with P1 (step 4). P2 performs a lookup in the P1 snoop request cache 414 (step 5), and inspects any hitting entry. If P2's identification flag is set in the hitting entry, the processor P2 clears its own identification flag (but not the identification flag of any other processor), enabling processor P1 to send snoop kill requests to P2 if P1 subsequently writes to the shared data granule. A hitting entry in which P2's identification flag is clear is treated as a cache 414 miss (P2 takes no action).

In general, in the embodiment depicted in FIG. 4—where each processor has a single snoop request cache associated with it—each processor performs a lookup only in the snoop request cache associated with it upon writing shared data, allocates a cache entry if necessary, and sets the identification flag of every processor to whom it sends a snoop request. Upon reading shared data, each processor performs a lookup in the snoop request cache associated with every other processor with which it shares data, and clears its own identification flag from any hitting entry.

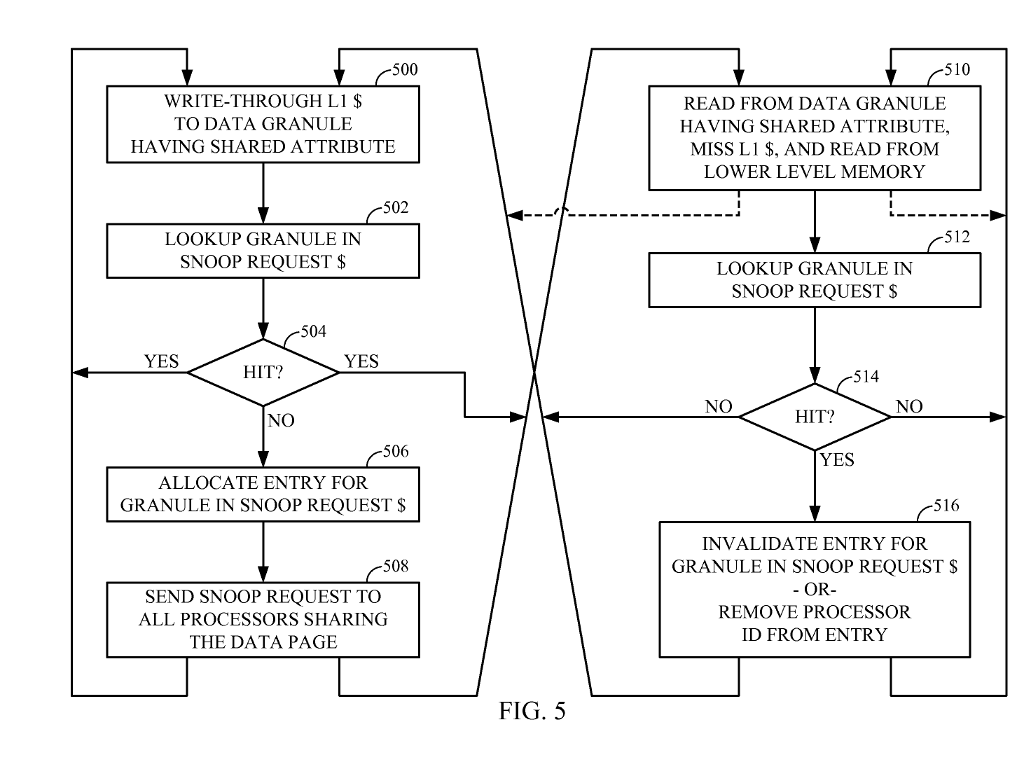

FIG. 5 depicts a method of issuing a data cache snoop request, according to one or more embodiments. One aspect of the method “begins” with a snooping entity writing to a data granule having a shared attribute at block 500. If the snooping entity is a processor, the attribute (e.g., shared and/or write-through) forces a write-through of the L1 cache to a lower level of the memory hierarchy. The snooping entity performs a lookup on the shared data granule in one or more snoop request caches associated with it at block 502. If the shared data granule hits in the snoop request cache at block 504 (and, in some embodiments, the identification flag for a processor with whom it shares data is set in a hitting cache entry), the snooping entity suppresses a data cache snoop request for one or more processors and continues. For the purposes of FIG. 5, it may “continue” by subsequently writing another shared data granule at block 500, reading a shared data granule at block 510, or performing some other task not pertinent to the method. If the shared data granule misses in a snoop request cache (or, in some embodiments, it hits but a target processor identification flag is clear), the snooping entity allocates an entry for the granule in the snoop request cache at block 506 (or sets the target processor identification flag), and sends a data cache snoop request to a processor sharing the data at block 508, and continues.

Another aspect of the method “begins” when a snooping entity reads from a data granule having a shared attribute. If the snooping entity is a processor, it misses in its L1 cache and retrieves the shared data granule from a lower level of the memory hierarchy at block 510. The processor performs a lookup on the granule in one or more snoop request caches dedicated to it (or whose entries include an identification flag for it) at block 512. If the lookup misses in a snoop request cache at block 514 (or, in some embodiments, the lookup hits but the processor's identification flag in the hitting entry is clear), the processor continues. If the lookup hits in a snoop request cache at block 514 (and, in some embodiments, the processor's identification flag in the hitting entry is set) the processor invalidates the hitting entry at block 516 (or, in some embodiments, clears its identification flag), and then continues.

If the snooping entity is not a processor with an L1 cache—for example, a DMA controller—there is no need to access the snoop request cache to check for and invalidate an entry (or clear its identification flag) upon reading from a data granule. Since the granule is not cached, there is no need to clear the way for another snooping entity to invalidate or otherwise change the cache state of a cache line when the other entity writes to the granule. In this case, the method continues after reading from the granule at block 510, as indicated by the dashed arrows in FIG. 5. In other words, the method differs with respect to reading shared data, depending on whether or not the snooping entity performing the read is a processor having a data cache.

According to one or more embodiments described herein, performance in multi-processor computing systems is enhanced by avoiding the performance degradations associated with the execution of superfluous snoop requests, while maintaining L1 cache coherency for data having a shared attribute. Various embodiments achieve this enhanced performance at a dramatically reduced cost of silicon area, as compared with the duplicate tag approach known in the art. The snoop request cache is compatible with, and provides enhanced performance benefits to, embodiments utilizing other known snoop request suppression techniques, such as processors within a software-defined snooper group and for processors backed by the same L2 cache that is fully inclusive of L1 caches. The snoop request cache is compatible with store gathering, and in such an embodiment may be of a reduced size, due to the lower number of store operations performed by the processor.

While the discussion above has been presented in terms of a write-through L1 cache and suppressing snoop kill requests, those of skill in the art will recognize that other cache writing algorithms and concomitant snooping protocols may advantageously utilize the inventive techniques, circuits, and methods described and claimed herein. For example, in a MESI (Modified, Exclusive, Shared, Invalid) cache protocol, a snoop request may direct a processor to change the cache state of a line from Exclusive to Shared.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of filtering a data cache snoop request to a target processor having a data cache, by a snooping entity, comprising:
performing a snoop request cache lookup in response to a data store operation; and
suppressing the data cache snoop request in response to a hit.

2. The method of claim 1 wherein suppressing the data cache snoop request in response to a hit further comprises suppressing the data cache snoop request in response to an identification of the snooping entity in a hitting cache entry.

3. The method of claim 1 wherein suppressing the data cache snoop request in response to a hit further comprises suppressing the data cache snoop request in response to an identification of the target processor in a hitting cache entry.

4. The method of claim 1 further comprising allocating an entry in the snoop request cache in response to a miss.

5. The method of claim 4 further comprising forwarding the data cache snoop request to the target processor in response to a miss.

6. The method of claim 4 wherein allocating an entry in the snoop request cache comprises including in the snoop request cache entry an identification of the snooping entity.

7. The method of claim 4 wherein allocating an entry in the snoop request cache comprises including in the snoop request cache entry an identification of the target processor.

8. The method of claim 1 further comprising
forwarding the data cache snoop request to the target processor in response to a hit wherein the target processor's identification is not set in the hitting cache entry; and
setting the identification of the target processor in the hitting cache entry.

9. The method of claim 1 wherein the snooping entity is a processor having a data cache, further comprising performing a snoop request cache lookup in response to a data load operation.

10. The method of claim 9 further comprising, in response to a hit, invalidating the hitting snoop request cache entry.

11. The method of claim 9 further comprising, in response to a hit, removing the processor's identification from the hitting cache entry.

12. The method of claim 1 wherein the snoop request cache lookup is performed only for data store operations on data having a predetermined attribute.

13. The method of claim 12 wherein the predetermined attribute is that the data is shared.

14. The method of claim 1 wherein the data cache snoop request is operative to change the cache state of a line in the target processor's data cache.

15. The method of claim 14 wherein the data cache snoop request is a snoop kill request operative to invalidate a line from the target processor's data cache.

16. A computing system, comprising:
memory;
a first processor having a data cache;
a snooping entity operative to direct a data cache snoop request to the first processor upon writing to memory data having a predetermined attribute; and
at least one snoop request cache comprising at least one entry, each valid entry indicative of a prior data cache snoop request;
wherein the snooping entity is further operative to perform a snoop request cache lookup prior to directing a data cache snoop request to the first processor, and to suppress the data cache snoop request in response to a hit.

17. The system of claim 16 wherein the snooping entity is further operative to allocate a new entry in the snoop request cache in response to a miss.

18. The system of claim 16 wherein the snooping entity is further operative to suppress the data cache snoop request in response to an identification of the snooping entity in a hitting cache entry.

19. The system of claim 16 wherein the snooping entity is further operative to suppress the data cache snoop request in response to an identification of the first processor in a hitting cache entry.

20. The system of claim 19 wherein the snooping entity is further operative to set the first processor's identification in a hitting entry in which the first processor's identification is not set.

21. The system of claim 16 wherein the predetermined attribute indicates shared data.

22. The system of claim 16 wherein the first processor is further operative to perform a snoop request cache lookup upon reading from memory data having a predetermined attribute, and to alter a hitting snoop request cache entry in response to a hit.

23. The system of claim 22 wherein the first processor is operative to invalidate the hitting snoop request cache entry.

24. The system of claim 22 wherein the first processor is operative to clear from the hitting snoop request cache entry an identification of itself.

25. The system of claim 16 wherein the at least one snoop request cache comprises a single snoop request cache in which both the first processor and the snooping entity perform lookups upon writing to memory data having a predetermined attribute.

26. The system of claim 16 wherein the at least one snoop request cache comprises:
a first snoop request cache in which the first processor is operative to perform lookups upon writing to memory data having a predetermined attribute; and
a second snoop request cache in which the snooping entity is operative to perform lookups upon writing to memory data having a predetermined attribute.

27. The system of claim 26 wherein the first processor is further operative to perform lookups in the second snoop request cache upon reading from memory data having a predetermined attribute.

28. The system of claim 26 further comprising:
a second processor having a data cache; and
a third snoop request cache in which the snooping entity is operative to perform lookups upon writing to memory data having a predetermined attribute.
